(19) United States
(12) Patent Application Publication
(10) Pub. No.: US 2019/0147462 A1
(43) Pub. Date: May 16, 2019

(54) HYBRID DEMAND MODEL FOR PROMOTION PLANNING

(71) Applicant: Target Brands, Inc., Minneapolis, MN (US)

(72) Inventors: Shubhankar Ray, Union City, CA (US); Saibal Bhattacharya, San Mateo, CA (US); Zeynep Erkin Baz, Mountain View, CA (US); Jagadeesh Balam, Campbell, CA (US)

(21) Appl. No.: 15/809,609

(22) Filed: Nov. 10, 2017

(51) Int. Cl. G06Q 30/02; G06N 99/00

(52) U.S. Cl. CPC G06Q 30/0202; G06N 99/005

(57) ABSTRACT

A computer-implemented method uses sales data to fit static parameters of a demand prediction model that predicts a current demand based in part on a previous demand. The static parameters and the sales data are then used to fit dynamic states of a structural time series model, wherein the dynamic states change over time and are different for different time periods. A time period for a future price is selected and the future price is applied to the structural time-series model using the dynamic states for the time period to generate an expected demand for the time period.

### BACKGROUND

Retailers set the prices for their goods and services in an effort to maximize revenue or margin. The total revenue from selling a good is found by multiplying the price of the good by the number of items sold or the item demand. Thus, to select the best price for a good, one needs to know the demand curve or the expected demand for different prices. In the context of promotion planning, we try to model the relationship between expected demand and promotional prices as well as regular prices. Since this relationship may depend on other factors like the seasonality or trend, holidays, ongoing promotions, demand in previous time periods and specific store locations, the model has to account for effects of all these factors.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method uses sales data to fit static parameters of a demand prediction model that predicts a current demand based in part on a previous demand. The static parameters and the sales data are then used to fit dynamic states of a structural time series model, wherein the dynamic states change over time and are different for different time periods. A time period for a future price is selected and the future price is applied to the structural time-series model using the dynamic states for the time period to generate an expected demand for the time period.

In accordance with a further embodiment, a demand prediction server includes a processor executing instructions to perform steps that include receiving a time period and a future price for a product and selecting fitted dynamic states of a structural time series model that have been fitted for the received period of time using static parameters that were trained together with an autoregression parameter for previous demand. Applying the selected fitted dynamic states and the future price to the structural time series demand model to predict a future demand for the product wherein the structural time-series model does not explicitly use a previous demand.

In accordance with a still further embodiment, a computer-implemented method includes using sales data to train parameters of a demand prediction model that predicts a current demand based in part on a previous demand. The parameters of the demand prediction model and the sales data are then used to fit a structural time-series model, wherein the structural time series model predicts demand without explicitly using a previous demand.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is flow diagram of a method of training and using demand models in accordance with one embodiment.

FIG. 2 is a block diagram of a server system for training and using demand models, in accordance with one embodiment.

FIG. 3 is a block diagram of a computing device that is used as either a client or server in accordance with the various embodiments.

### DETAILED DESCRIPTION

Promotion price optimization can be computationally time consuming when the model for future demand depends explicitly on prior demand levels. In particular, price optimization cannot happen independently for every time period but involves a recursion because the revenue at any time period depends on predicted demand of other periods due to the recursive nature of the model. This slowness is compounded when the price optimization is performed for each of the thousands of goods across all of a retailer's store locations As a result, price optimization with explicit dependency on previous demand is computationally intractable, meaning that it cannot be solved by a computer in polynomial time. In order to make price optimization tractable, improvements in the operation of the computer are needed.

The embodiments described below provide a Panel Autoregressive Distributed Lag (ARDL) Model that includes a prior demand as a predictor for predicting future demand. The model has a number of static parameters (or parameters that do not change over time) that can be estimated based on archived sales data. The estimated static parameters are plugged into a second model that predicts a future demand without explicitly using a past demand. In particular, the second model is a structural time-series model that uses dynamic states to predict demand. The dynamic states change between time periods such as between weeks and can be estimated sequentially using a Kalman Filter based on actual demand and pricing and the value for the dynamic states for the previous time period. This allows us to better adapt to and keep track of the evolving time series of demand over time and provide better forecasts. Because the structural time-series model does not use past demand explicitly, the computer system is able to predict future demand faster compared to the Panel ARDL and the problem of optimizing future prices becomes tractable.

More generally, a computer-implemented method in accordance with some embodiments first fits a static model (where parameters do not change over time) to historical sales, prices and promotion flags for an item across all store groups where it is sold. Fitting the static model to the historical data involves estimating static parameters like the annual seasonal profile of demand, holiday effects and promotional price elasticities which measure the sensitivity of demand to price changes under different types of promotions. Next a structural time-series model (where parameters are allowed to change over time to adapt to evolving time series), is fitted to the same historical data by using the static parameter estimates from the first step. The structural model fit generates estimates of dynamic states like the average sales level and the strength of annual seasonality. The estimates of the static parameters and dynamic states together encapsulate all the information needed to calculate the forecasts for any future time periods given future promotional flags and prices. In contrast to one unified model which can provide estimates for both static parameters and dynamic states, this compartmentalization of the modeling process into separate models helps to reduce the total computational time.

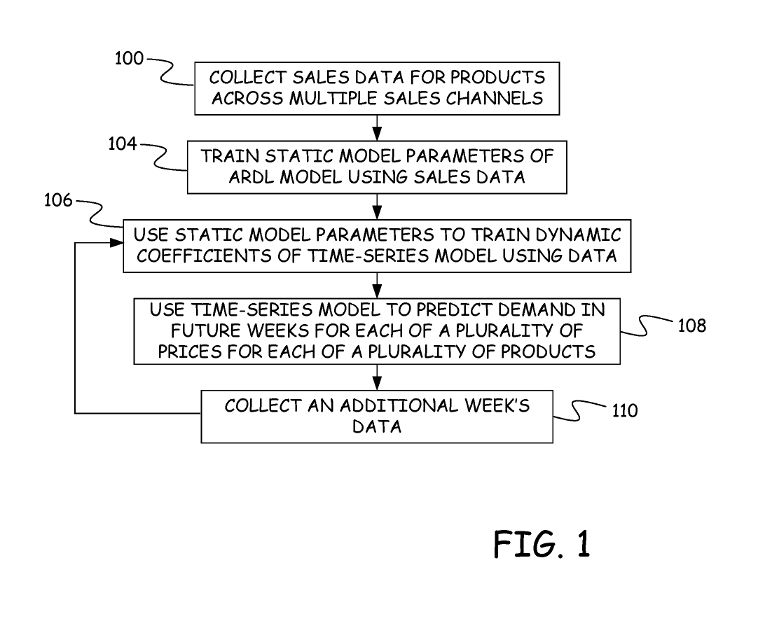

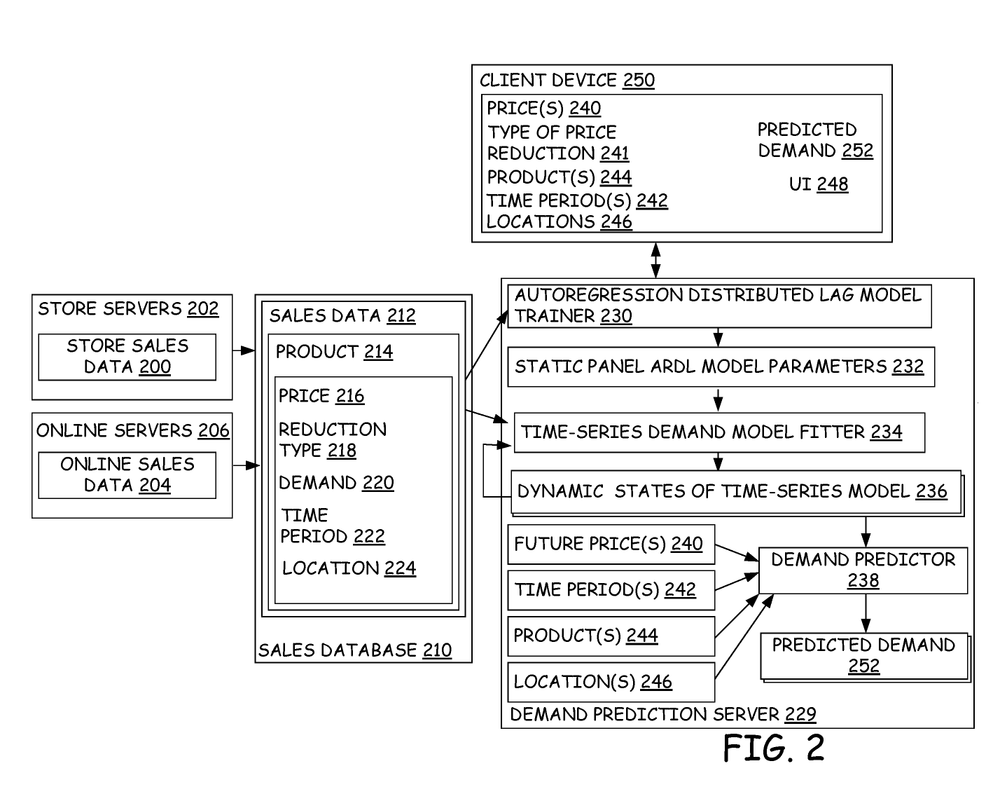

FIG. 1 provides a flow diagram and FIG. 2 provides a block diagram of a method and system for training and using demand prediction models in accordance with one embodiment. At step 100, sales data for purchased items is collected from one or more sales channels. In the embodiment of FIG. 2, the sales data includes store sales data 200, which is transmitted from store server(s) 202 to a sales database 210 and online sales data 204, which is transmitted from online server(s) 206 to sales database 210. The sales data may be transmitted as sales occur or as part of a periodic batch process. The sales data from the different channels is stored as sales data 212 in sales database 210.

For each product 214 that is sold, sales data 212 includes one or more records indicating a price 216 of the product, a reduction type 218 (if any), a demand 220 (the amount sold), and a date or time period 222 when the product was sold at price 216. Reduction type 218 indicates how the price was set such as through a store coupon, a manufacturer's coupon, or an in store discount such as a Temporary Price Cut (TPC) or a Circular promotion, whereby a price cut is advertised in weekly circulars for stores. In accordance with one embodiment, date or time period 222 designates one or more weeks when price 216 was in effect. Note that different prices can be applied to a single product during a same time period 222 when some consumers use coupons for the product while other consumers do not use coupons.

The records for each product also include a location 224 of the customer when the sale took place. For example, the location descriptions can include a hierarchical description of a location formed of a store identifier at the lowest level, a district identifier at an intermediate level, and an “adpatch” identifier at an upper level. In such embodiments, a district represents a collection of stores that are geographically close to each other and an adpatch represents a collection of districts that each receive the same advertisements from the retailer. For online purchases, the location is set based on an estimate of the closest store to the purchaser's device when the purchaser used the device to make the purchase.

At step 104, static model parameters 232 of a Panel Autoregression Distributed Lag (ARDL) Model are trained by a model trainer 230 executed on a demand prediction server 229 using sales data 212. In accordance with one embodiment, model trainer 230 trains a model that predicts a log of a demand y_{i,j,t} for an ith adpatch, a jth district in week t as:

log y_{i,j,t}=(1+γ)log y_{i,j,t-1}+μ_{i,j}+s(t)+h(t)+d(t)+α_{i,j}(t)(log(p_{i,j,t})−log(p_{i,j,t-1}))+βlog(p_{i,j,t-1})+∈_{i,jt} (1)

where,

$${μ}_{i , j} = μ + {m}_{i} + {m}_{i , j} , \\ h ( t ) = {h}_{easter} I ( t = easter ) + … + {h}_{blkfri} I ( t = blkfri ) , \\ d ( t ) = dI ( t ∈ display weeks ) , \\ {α}_{i , j} ( t ) = \{ \begin{matrix}α ( t ) + {a}_{i} + {a}_{i , j} , & TPC promotion , \\ α ( t ) + {α}_{circ} + {a}_{i} + {a}_{i , j} , & Circular promotion ,\end{matrix} \\ {m}_{i} ∼ N ( 0 , {u}_{1}^{2} ) , {m}_{i , j} ∼ N ( 0 , {u}_{2}^{2} ) , {a}_{i} ∼ N ( 0 , {w}_{1}^{2} ) , \\ {a}_{i , j} ∼ N ( 0 , {w}_{2}^{2} ) , and {ϵ}_{i , j , t} ∼ N ( 0 , {σ}^{2} )$$

and where μ_{i,j} is the location-specific intercept or log-baseline demand for adpatch i and district j, s(t) is a smooth exogenous annual seasonal profile function satisfying a periodicity condition s(t+52)=s(t), h(t) encapsulates effects on demand of holidays like Easter or Black Friday on specific calendar weeks, d(t) is the effect on demand of weeks when the item is on display, α_{i,j}(t) are promotional elasticities by location and time of the year satisfying a periodicity condition similar to s(t), β is the long-run elasticity used as a proxy for regular price elasticity (in absence of insufficient data on regular price changes to directly estimate regular price elasticity), 1+γ is the autoregression (AR(1)) parameter applied to the previous week's demand, log y_{i,j,t-1} is the log demand for the previous week in district j of adpatch i, p_{i,j,t} is the price of the product for the current week t, in district j and adpatch i, p_{i,j,t-1} is the price in previous week t−1, and ∈_{i,j,t} is a noise term that is assumed to be normally distributed with variance σ². To avoid over-parameterization in (1), a linear mixed-effects (LME) approach is used where all the location-specific parameters are viewed as fixed chain-level parameters plus random location-specific deviations. The random specification of location-specific deviations in the LME formulation provides natural shrinkage towards the chain-level parameters when there is insufficient data or higher variation at specific locations.

Thus, the log-baseline demand μ_{i,j} at any district is the sum of a chain-wide average store demand μ plus an adpatch deviation mᵢ plus a district-level deviation m_{i,j}. The promotional price elasticity α_{i,j}, has two different descriptions. The base description includes a chain-wide price elasticity function α(t) during temporary price cuts (or most common forms of promotions) plus an adpatch deviation αᵢ and a district level deviation α_{i,j}. Following common LME parlance, the deviations at the adpatch or district level are assumed to be normally distributed random parameters with variances w₁² and w₂², respectively. For price changes that are due to instore circulars, an additional term α_{circ} is added.

Model trainer 230 estimates Panel ARDL model parameters 232 using historic pricing and demand values for each district in each adpatch during each of 52 weeks in a year. Multiple years of past data may be used to estimate the static Panel ARDL model parameters 232. In accordance with one embodiment, the Panel ARDL model is fitted using a restricted maximum likelihood (REML) approach typically used for fitting LMEs.

Panel ARDL model parameters 232 are static in the sense that they do not change with time over the duration of historical data.

In Equation 1, it can be seen that the log demand for a week t (log y_{i,j,t}) is a function of the log demand of a previous week t−1(log y_{i,j,t-1}). Thus, a current demand is dependent upon a previous demand. This makes it difficult to use Equation 1 for price optimization which must now also be performed recursively. This greatly increases the number of computations that must be performed and is compounded if multiple prices are to be evaluated for each of the weeks and if demand for all of the thousands of products sold by a major retailer are to be determined.

To overcome this problem, the present inventors plug-in the static parameters 232 from the Panel ARDL model to fit a dynamic structural time series model 236. The parameters from this model are dynamic in that the parameters change from week-to-week. By using a structural time series model with dynamic states, the present inventors are able to remove explicit dependence of the log demand on previous log demands. This allows future prices to be optimized without first optimizing prices on other future periods thereby improving the operation of the computer so that it makes the overall price optimization problem spanning many thousand items across roughly 230 districts tractable.

One example of a time-series demand model used in the various embodiments is:

log y_{i,j,t}˜N(μ_{i,j,t}+s(t)η_{i,j,t}+h(t)+d(t)+α_{i,j}(t)(log(p_{i,j,t})−log(p̅_{i,j,t}))+βlog(p̅_{i,j,t}),σ²), (2)

where

μ_{i,j,t}=μₜ+m_{i,t}+m_{i,j,t},

η_{i,j,t}=ηₜ+h_{i,t}+h_{i,j,t}

and where, log y_{i,j,t} is the log demand for adpatch i, district j, in week t, μ_{i,j,t} is a latent baseline dynamic state representing a baseline amount of demand, η_{i,j,t} is a latent seasonal state that scales the seasonal profile s(t) for a particular adpatch and district, p_{i,j,t} and p̅_{i,j,t} are the promotional price and regular price for adpatch i, and district j at time t, α_{i,j}(t) is the corresponding promotional price elasticity and β is the regular price elasticity, which in one embodiment is the same for every week. Note that the structural time series model explains serial correlation in time series without explicitly using previous demand in the model formulation.

Latent dynamic states {μ_{i,j,t}, η_{i,j,t}} are assumed to be the sum of a chain-level dynamic states {μₜ, ηₜ} (chain-level baseline demand state and retail chain-level seasonal state), states for dynamic adpatch-level deviations {m_{i,t}, h_{i,t}} (also referred to as first hierarchy level variations) and states for dynamic district-level deviations {m_{i,j,t}, h_{i,j,t}} (also referred to as second hierarchy level variations) respectively. Each of these dynamic states change from week-to-week, where the changes are limited based on allowed variances from the previous week's dynamic states and deviations:

(μₜ, m_{i,t}, m_{i,j,t})′˜N[(μₜ₋₁, m_{i,t-1}, m_{i,j,t-1})′, diag(u₁, u₂, u₃)σ²],

(ηₜ, h_{i,t}, h_{i,j,t})′˜N[(ηₜ₋₁, h_{i,t-1}, h_{i,j,t-1})′, diag(v₁, v₂, v₃)σ²],

where u₁, u₂, u₃, v₁, v₂, and v₃ are hyperparameters that determine the rate at which the latent processes evolve. These conditional distributions essentially define latent processes {μₜ}, {ηₜ}, {m_{i,t}}, {h_{i,t}}, {m_{i,j,t}} and {h_{i,j,t}} whose rate of change over time is determined by the hyperparameters u₁, v₁, u₂, v₂, u₃, and v₃ respectively.

The promotional price sensitivities α_{i,j}(t) have additive contributions from a chain-level elasticity αₜ, an adpatch-level deviation αᵢ and a district-level deviation α_{i,j}, all of which are pre-estimated using the static Panel ARDL model. Thus, separate promotional price elasticities are determined for different forms of price reduction: store temporary price cuts, circulars and other discounts. As a result, when predicting the future demand, the type of price reduction is used to select the proper promotional price elasticity.

In step 106 of FIG. 1, a structural time series demand model fitting algorithm 234 on demand prediction server 229 fits the dynamic states of a structural time series model 236 in a sequential fashion by determining the values of the dynamic states for one week based on the data for that week and values of the dynamic states in the previous week, the static ARDL model parameters 232, and prices and demand values in sales data 212 for the current week. Note that the structural time series model can be written in a state-space form, for all t=1, . . . ,T with T as the number of weeks of historical data,

Yₜ=Xₜθₜ+Zₜuₜ+εₜ, εₜ˜N(0, Rₜ)

θₜ=θₜ₋₁+ζₜ, ζₜ˜N(0, Qₜ)

where,
a. Yₜ={log y_{i,j,t}}, θₜ=μₜ, ηₜ, {m_{i,t}}, {h_{i,t}}, {m_{i,j,t}}, {h_{i,j,t}}}∀i,j and t=1, . . . ,T.
b. The matrix Xₜ consists of entries 1 and s(t), such that multiplying it by the parameters θₜ leads to {μ_{i,j,t}+s(t)η_{i,j,t}}∀i,j and t=1, . . . , T.
c. The matrix Zₜ consists of holiday, item display week indicators, difference of log-promotional prices from log-regular price and log-regular prices such that multiplying it by the vector of static parameters uₜ leads to {h(t)+d(t)+α_{i,j}(t)(log(p_{i,j,t})−log(p̅_{i,j,t}))+β log(p̅_{i,j,t})}} ∀t. The vector of static parameters uₜ is pre-estimated by the Panel ARDL.
d. Finally, the error and prior covariances are given by Rₜ=σ²I and Qₜ=σ² diag(u₁, v₁, u₂, v₂, . . . , u₃, v₃).

In accordance with one embodiment, fitting algorithm 234 fits dynamic states and hyperparameters {Rₜ, Qₜ} 236 using maximum likelihood estimation. The estimated Qₜ essentially allows limited change in the dynamic states from one week to the next based on the above equations so that the structural time series model more accurately predicts demand. We do maximum likelihood estimation, by alternating between a Kalman Filter to estimate {θₜ}_{1, . . . ,T} and maximize the marginal likelihood to estimate {Rₜ, Qₜ}.
a. Given some values for {Rₜ, Qₜ}, we fit the parameters {θₜ}_{1, . . . ,T} using the following Kalman Filter equations:
   i. At t=0, assume θ₀˜N(ϑ₀, P₀) with \hat{θ}₀=ϑ₀ as some prior estimate of the states initialized as a random vector and a prior covariance matrix P₀ initialized with a large constant term on the diagonal.
   ii. For t=1, . . . ,T the mean and covariances of the states are updated as,

vₜ=Yₜ−Xₜϑₜ₋₁−Zₜuₜ, Fₜ=XₜPₜ₋₁Xₜ′+Rₜ,

Kₜ=Pₜ₋₁Xₜ′,

ϑₜ=ϑₜ₋₁+KₜFₜ⁻¹vₜ, Pₜ=Pₜ₋₁−KₜFₜ⁻¹Kₜ′+Qₜ.
iii. At the final time period t=T, the estimate of the states \hat{θ}_{T}=ϑ_{T}, which can be used to generate forecasts for any time period t>T given by Xₜ, Zₜ and uₜ for future weeks.
b. The Kalman Filter automatically leads to estimates of the marginal likelihood that does not depend on {θₜ}_{1, . . . ,T}. The log-marginal likelihood is given by

$$constant - \frac{1}{2} {\sum }_{t = 1}^{T} \vert {F}_{t} \vert + \frac{1}{2} {\sum }_{t = 1}^{T} {v}_{t} {F}_{t}^{- 1} {v}_{t}^{′}$$

and is numerically maximized to estimate {Rₜ, Qₜ}.

The Kalman Filter has a time complexity of O(M³T), where M is the total number of districts and T is the number of weeks of historical data. Therefore the overall time complexity of estimating the hyperparameters (which is O(NM³T) with N as the number of iterations required for the numerical maximization of the log-marginal likelihood) is very large. Since the hyperparameters {Rₜ, Qₜ} are not expected to change a lot between weeks, they are estimated only once every few weeks. In a similar fashion, the static parameters uₜ from the ARDL model are not expected to change drastically between weeks and estimated once every few weeks. Given estimates of {Rₜ, Qₜ} and uₜ, for every new week of data the various embodiments require only one iteration of the Kalman Filter which updates the states by looking at the new week of data and the last available states. On a weekly basis therefore various embodiments just bear a very small time complexity of O(M³). This strategy also allows the various embodiments to be more memory efficient in the sense that the embodiments just need to load the last week of data into memory for updating the states.

In accordance with one embodiment, the structural time series model fitter 234 fits and stores a separate set of states and hyperparameters {Rₜ, Qₜ} for every combination of adpatch, division, and week in a year.

At step 108, the dynamic states of the structural time series model are used to predict demand in future weeks for each of a plurality of prices and for each of a plurality of products. In particular, a demand predictor 238 on demand prediction server 229 receives future prices 240, type of price reduction 241, time periods 242, products 244 and locations 246 through a user interface 248 on a client device 250. In accordance with one embodiment, user interface 248 allows the user to designate only a single future price, a single type of price reduction 241, a single time period 242, a single product 244 and a single location 246 when requesting a demand prediction. In accordance with other embodiments, user interface 248 allows the user to designate one or more values for each of future prices 240, type of price reduction 241, time periods 242, products 244 and locations 246. Before predicting the demand, demand predictor 238 forms all possible combinations of the future prices 240, type of price reduction 241, time periods 242, products 244 and locations 246 indicated on user interface 248. For each combination of: type of price reduction 241, time periods 242, products 244 and locations 246, demand prediction server 229 selects the dynamic states of the time-series model 236 that were trained for that combination. For each combination, demand prediction server 229 then sequentially applies each of future prices 240 to the time-series demand model with the selected dynamic states for that combination to predict a separate future demand for each future price and the combination. For example, if cereal is selected as the product, the 23rd week of the year is selected as the time period, a Minneapolis adpatch is selected as the location, and a store coupon is selected as the price reduction type, the dynamic states trained for cereal, for the 23rd week of the year, for all districts in the Minneapolis adpatch, and for store coupons would be selected and used to predict one or more future demands in response to one or more future prices. Note that the 23rd week may be several weeks in the future when the demand is predicted. Thus, in step 108, a future demand is predicted based on a future price of a product.

In accordance with one embodiment, the predicted demand(s) 252 are displayed on user interface 248 of client device 250.

At step 110, an additional week's worth of sales data is collected from store servers 202 and online servers 206. In response, structural time series model trainer 234 updates dynamic states 236 at step 106. The process then returns to step 108 to use the new dynamic states for predicting demand. Thus, by using a structural time series model, it is possible to update the demand model quickly as new sales data becomes available because the time-series model can be trained using the latest sales data and the previous values of the dynamic states instead of using batch fitting, which requires all of the sales data to be loaded into memory.

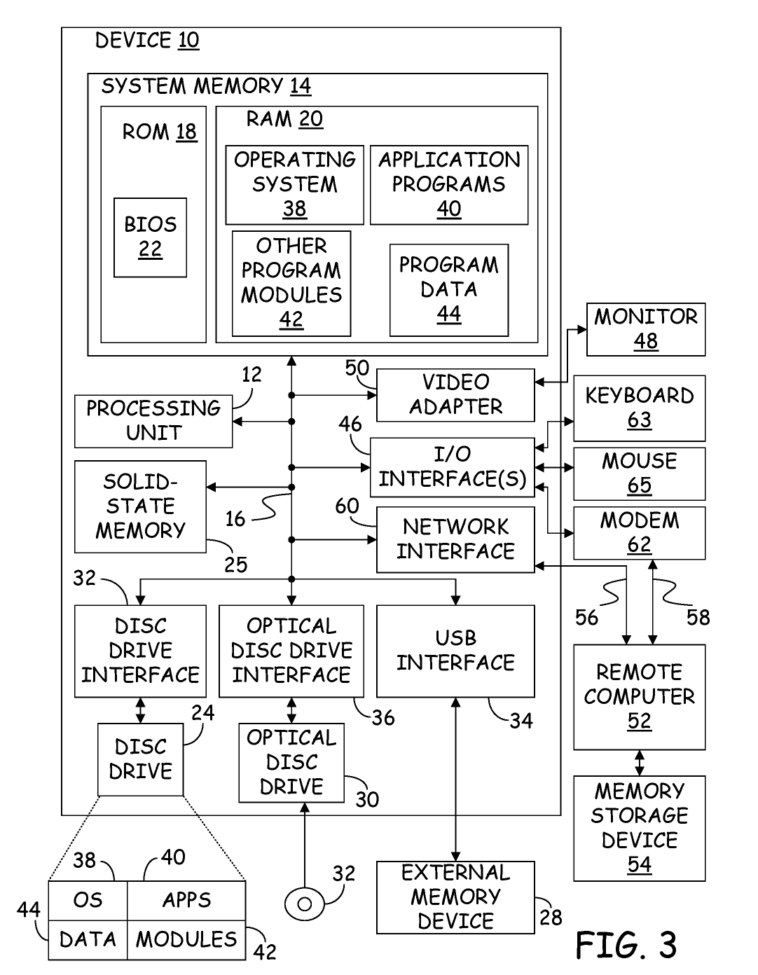

FIG. 3 provides an example of a computing device 10 that can be used as a server device or client device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of autoregression distributed lag model trainer 230, time-series demand model fitter 234, and demand predictor 238, for example. Program data 44 may include data such as sales data 212, static model parameters 232, dynamic states of a structural time-series model 236, future price(s) 240, time period(s) 242, product(s) 244, location(s) 246 and predictor demand 252, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 3. The network connections depicted in FIG. 3 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 3 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
using sales data to train static parameters of a demand prediction model that predicts a current demand based in part on a previous demand;
using the static parameters and the sales data to train dynamic states of a structural time series model, wherein the dynamic states change over time and are different for different time periods;
selecting a time period for a future price;
applying the future price to the time series model using the dynamic states for the time period to generate an expected demand for the time period.

2. The computer-implemented method of claim 1 wherein the static parameters comprise an autoregression coefficient that is applied to the previous demand in the demand prediction model.

3. The computer-implemented method of claim 2 wherein the static parameters further comprise a promotional price elasticity that is applied to a current price change in the demand prediction model.

4. The computer-implemented method of claim 3 wherein the static parameters further comprise a regular price elasticity that is applied to a past price in the demand prediction model.

5. The computer-implemented method of claim 1 wherein the dynamic states comprise a baseline demand state that indicates baseline amount of demand.

6. The computer-implemented method of claim 5 wherein the baseline demand state comprises a sum of a retail chain-level baseline demand state, an first hierarchy level variation and a second hierarchy level variation.

7. The computer-implemented method of claim 1 wherein the dynamic states comprise a season state that represents the elasticity of demand to a seasonal profile of demand.

8. A demand prediction server comprising a processor executing instructions to perform steps comprising:
receiving a time period and a future price for a product;
selecting fitted dynamic states of a structural time series model that have been fitted for the received period of time using static parameters that were trained together with an autoregression parameter for previous demand; and
applying the selected fitted dynamic states and the future price to the structural time series demand model to predict a future demand for the product wherein the structural time-series model does not explicitly use a previous demand.

9. The demand prediction server of claim 8 wherein the fitted dynamic states comprise a baseline demand state.

10. The demand prediction server of claim 9 wherein the baseline demand state comprises a sum of a retail chain-level baseline demand state, a first hierarchy level variation and a second hierarchy level variation.

11. The demand prediction server of claim 8 wherein the fitted dynamic states comprise a seasonal state.

12. The demand prediction server of claim 11 wherein the seasonal state comprises a sum of a retail chain-level seasonal state, a first hierarchy level variation, and a second hierarchy level variation.

13. The demand prediction server of claim 8 wherein the static parameters comprise a parameter representing an effect on demand caused by a product being on display

14. The demand prediction server of claim 8 wherein the static parameters comprise a promotional price elasticity and a regular price elasticity.

15. A computer-implemented method comprising:
using sales data to train parameters of a demand prediction model that predicts a current demand based in part on a previous demand; and
using the parameters of the demand prediction model and the sales data to fit a structural time-series model, wherein the structural time series model predicts demand without explicitly using a previous demand.

16. The computer-implemented method of claim 15 wherein fitting the structural time series model comprises fitting dynamic states for each of a plurality of time periods, wherein the dynamic states change between time periods.

17. The computer-implemented method of claim 16 wherein the time-series model comprises a plurality of promotional price elasticities, wherein each promotional price elasticity is associated with a respective type of price reduction.

18. The computer-implemented method of claim 16 wherein the dynamic states comprise a baseline demand state.

19. The computer-implemented method of claim 18 wherein the dynamic parameters further comprise a seasonality profile parameter.

20. The computer-implemented method of claim 19 wherein the dynamic states comprise a seasonal state that scales the seasonal profile parameter.
